(19) United States
(12) Patent Application Publication
(10) Pub. No.: US 2015/0116321 A1
(43) Pub. Date: Apr. 30, 2015

(54) Camouflage and Similar Patterns Method and Technique of Creating Such Patterns

(71) Applicant: Travis Christopher Fortner, La Crosse, WI (US)

(72) Inventor: Travis Christopher Fortner, La Crosse, WI (US)

(21) Appl. No.: 14/066,672

(22) Filed: Oct. 29, 2013

(51) Int. Cl. F41H 3/00; G06T 17/10

(52) U.S. Cl. CPC F41H 3/00; G06T 17/10
USPC 345/420

(57) ABSTRACT

A method for making a camouflage pattern. Relying on a programmed computer to arrange a plurality of three dimensional digital models with a solid textured surface with a digital three dimensional scene. Using a programmed computer to apply effects or applications realistically applying lighting, shadow, absorption, reflections, refraction, florescence and transport to the digital three dimensional scene. Applying coloration to the three dimensional digital models and the back-ground to match the natural coloration of the objects modeled or to conceal a wearer or object bearing the pattern in a physical environment. The depth of field of the scene is manipulated to mimic the effect of focus in the human eye. The resulting realistic, digital, three-dimensional scene is then converted to a two dimensional image on a computer screen, printed on a substrate or saved as a digital data file through a process called rendering. The resulting two dimensional pattern is then repeated to create a larger pattern with continuous images. The camouflage pattern is then applied to a substrate such as film or fabric to be made into an article of manufacture.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

1. The Field of the Invention

This invention relates to patterns for camouflaging a user or apparatus and to novel methods and techniques for making a pattern for camouflage.

2. The Background Art

Camouflage patterns of one form or another have been in use since human first began hunting animals for food. The modern era of camouflage began in World War I, where asymmetrical shapes of colors selected to blend into the environment were printed on fabrics and painted on equipment. These patterns have been designed to camouflage people, equipment, shelter and other objects in a natural, outdoor environment. Camouflage patterns have been created for tactical use for the military or for concealment of hunting or other outdoors sports. Camouflage utilizing shapes and patterns found in nature has been in use since World War I. The design of camouflage advanced during World War II to include the use of two or three contrasting colors to break up the silhouette of people or equipment. The two or three color camouflage designs were utilized for 40 years after World War II in various patterns and designs.

Modern Camouflage design began in the mid to late 1980's and has three general methods of creation. One method utilizes fractals and pixilated random patterns in two or three colors to break up the outline of the human form. For example, in Oswald, U.S. Pat. No. 7,775,919 a camouflage system is used to create a camouflage pattern consisting of pixilated geometric shapes and includes the addition of graphic images of natural objects. A second method of creating camouflage patterns is to use three dimensional elements on the fabric or material of the garment. These three dimensional elements consist of fabric designed to look like plant like materials [cite traditional ghillie] or the use of contrasting nap or fabric finishes in an attempt to add depth. For example, in Muirhead, U.S. Pat. No. 6,500,214 the camouflage covering uses dyed jute strands and netting as the three dimensional element. Another example of attempting to add three dimensional elements is found in Tarrell, U.S. Pat. No. 7,832,067 where certain sections of the fabric have fleecing applied, creating various depths and relief within the fabric. Three dimensional camouflage created by utilizing materials or fabric suffer from several drawbacks. These systems are cumbersome, bulky, noisy and often don't create sufficient depth to create a true three dimensional effect.

The third branch uses images of natural objects to create more realistic patterns. One method of creating realistic patters is to uses artistic renderings of natural patterns, such as illustrations of branches, leaves and tree bark. For example, in Engel, U.S. Pat. No. D526,126 the pattern is a combination of photographs and artistic rendering of trees and leaves. This method of rendering has drawbacks, due to the subjective nature of an artist's interpretation. Artistic renderings also inaccurately reproduce natural lighting and often have a “flat” look, that is, they do not appear to have depth of perspective to the human or animal eye.

Another method of creating realistic natural camouflage is to use photographs as a basis for the design. For example the popular camouflage lines RealTree® and Mossy Oak© utilize digitized photographs as the basis for some of their camouflage patterns. The photographs are typically entered into a computer and manipulated with software to create a random, high contrast pattern. These patterns attempt to achieve a three dimensional effect by utilizing perspective, usually through the addition of a foreground, mid-ground and background elements which overlap each other. The foreground, mid-ground, and background are created by layering photographic images stored in digital form on top of one another. These high contrast patterns rely on the foreground image to break-up the human form and lack a plurality of disruptive patterns. These patterns are also limited by reliance on photographs. The photographic based images contain distortions and hyper reflections found in a photograph due to the limitations of lenses. The patterns still appear flat to the human eye even with of the addition of artistically rendered or photographic images of natural objects. Photographic based images also suffer from inaccurate or contradictory application of light sources. A photographic based pattern can be made up of several different photographs, taken at different times of the day and with a different angle, source and qualities of light. When combined into one pattern image it can often lead to images which have multiple different, and at times contradictory, sources of light. Anther limitation with photographic based images is the application of shading and shadows. Because a photographic based image can be made up of several different photographs taken at different times of the day and with different angles, sources and qualities of light, the resulting shadows in a composite pattern are unrealistic, inaccurate and contradictory. The resulting composite pattern often has shading which could not naturally occur in the physical world. Sometimes the artist will attempt to mitigate this short coming by applying shading and shadows by hand. This process also leads to further limitations, since it is based on the subjective expression of the artist and is often inaccurate when compared to reality. Photographic based images, especially composite images, have difficulty realistically replicating natural environmental effects such as rain, fog and snowfall. Another limitation of reliance on photographs is the resolution of the resulting images. When photographic images are enlarged, they begin to appear grainy and lose resolution.

### BRIEF DESCRIPTION

A camouflage pattern or system is provided in accordance with embodiments of the invention. The pattern or system includes an image rendering of a three dimensional natural environment having natural or non-natural elements therein. The rendered image, with rendered three dimensional objects placed continuously throughout the rendered image at various depths. The three dimensional objects depict environmental elements which include trees, branches, leaves, rocks, grasses, plants, bushes, shrubs, ferns, reeds, water, wildlife, deer, turkeys, elk, moose, hogs, ducks, geese, fish, skulls, antlers and bones. In another aspect the rendered three dimensional objects depict non-natural elements which include cubes, cuboids, square based pyramids, cones, triangular prisms, triangular based pyramids, cylinders, spheres, rhombohedra, pentagonal prism, tetrahedron or other solid geometrical shapes.

In various embodiments a pattern or apparatus, method and system in accordance with the present invention may include developing a mathematical representation of the three dimensional structure and surface of environmental elements, physical objects and solid shapes utilizing three dimensional modeling software in a programmed computer. The source for the environmental elements which are utilized to create the three dimensional models include but are not limited to trees, branches, leaves, rocks, grasses, plants, bushes, shrubs, ferns, reeds, water, wildlife, deer, turkeys, elk, moose, hogs, ducks, geese, fish, skulls, antlers and bones. The source for the non-natural physical objects utilized to create the three dimensional models include but are not limited to firearms, vehicles, tractors, boats, aircraft, bows, arrows, bullets, military vehicles and military equipment. The source for the solid shapes which are utilized to create the three dimensional models include but are not limited to cubes, cuboids, square based pyramids, cones, triangular prisms, triangular based pyramids, cylinders, spheres, rhombohedra, pentagonal prism, tetrahedron or other solid geometrical shapes. The three dimensional models are saved as a digital data set in a programmed computer or other digital media storage device. The three dimensional models are then placed into a digital three dimensional space which resides within a programmed computer, known to those skilled in the art as a scene, at varying levels of depth, including the foreground, mid-ground and background. The foreground, mid-ground and background of the scene will include the placement of the three dimensional models, including models of trees, branches, leaves, rocks, grasses, plants, bushes, shrubs, ferns, reeds, water, wildlife, deer, turkeys, elk, moose, hogs, ducks, geese, fish, skulls, antlers and bones. In another aspect the foreground, mid-ground, and background of the scene will include the placement of the three dimensional models including models of cubes, cuboids, square based pyramids, cones, triangular prisms, triangular based pyramids, cylinders, spheres, rhombohedra, pentagonal prism, tetrahedron or other solid geometrical shapes. In another aspect the foreground, mid-ground, and background of the scene will include the placement of three dimensional models including firearms, vehicles, tractors, boats, aircraft, bows, arrows, bullets, military vehicles and military equipment. The three dimensional models can be covered with a textured surface that is a highly detailed representation of the surface of the object being modeled or a wholly created surface designed by one skilled in the art. The textured surface can include coloration that are the natural colors of the natural elements, physical objects, animals, fowl, or the environment. In another aspect the textured surface can include coloration that include red, yellow, blue, green, orange, purple, brown, tan, gray, black, white but not limited to the foregoing colors.

The resulting three dimensional digital scene can be transformed by a programmed computer to create a digital two dimensional image in a process called rendering. The three dimensional image can be rendered onto a computer screen, on a printed substrate or saved as a digital data set. The focal plane and depth of field of the three-dimensional scene can be programmed and adjusted to mimic the depth of field and perception of the human or animal eye. The resulting rendered digital two dimensional images contain three dimensional lighting, shading and effects which is indistinguishable from the human perception of reality. Prior to rendering, effects can be applied to the digital three dimensional scene using a programmed computer to adjust the reflection/scattering of light and can include flat shading, Gouraud shading, texture mapping, Phong shading, Bump mapping or Cel shading. The digital three dimensional scene can also be manipulated with techniques through the aid of a programmed computer to apply ray tracing. Ray tracing is a technique for generating an image by tracing the path of light through pixels in an image plane and simulating the effects of its encounters with the three dimensional models such as absorption, reflection, refraction and fluorescence. The digital three dimensional scene can also be manipulated with effects using a programmed computer to apply radiosity, a rendering algorithm which gives a realistic rendering of shadows and diffuse light. The digital three dimensional scene can also be manipulated with effects using a programmed computer to apply transport which models how illumination in a scene gets from the light source point to the surface of the three dimensional models placed within the scene. The digital three dimensional scene can also be manipulated with effects using a programmed computer to apply global illumination including individual or a plurality of algorithms simulating how light interacts with solid objects such as radiosity, ray tracing, beam tracing, cone tracing, path tracing, Metropolis light transport, ambient occlusion, photon mapping, and image based lighting.

In one embodiment the digital three dimensional models may be manual modeled using a programmed computer in a manner similar to plastic arts such as sculpting. In another embodiment the three dimensional models may be created by a device which analyzes a real-world object or environment to collect data on its shape and appearance. The device may scan the object utilizing contact, non-contact active, time-of-flight, triangulation, conoscopic holography, hand-held laser, structured light, modulated light, stereoscopic, photometric or silhouette but is not limited to the foregoing methods. In another embodiment the three dimensional models can be created by scanning a two dimensional image into a digital data set and using software in a programmed computer, transforming the two dimensional image data set into a digital three dimensional model. In another embodiment the three dimensional models may be selected from a data base of previously created three dimensional models.

In one aspect, the system in accordance with the embodiments of the invention provides an article of manufacture and a pattern. The article suitably includes a surface having the pattern of repeating images of the two dimensional rendering in accordance with embodiments of the invention incorporated therein or applied thereon. The article is suitably, for example, a weapon, vehicle, fabric, clothing or outdoor equipment.

In another aspect, the camouflage material includes a repeating pattern of the two dimensional rendering of the scene depicting a realistic, three dimensional depiction of a created natural or non-natural scene. Specifically, the material includes a plurality of digital three dimensional models of physical objects or solid shapes placed in varying depth in the scene and including a foreground, mid-ground and background. The three dimensional models of physical object or sold shapes includes trees, branches, leaves, rocks, grasses, plants, bushes, shrubs, ferns, reeds, water, wildlife, deer, turkeys, elk, moose, hogs, ducks, geese, fish, skulls, antlers, bones, firearms, vehicles, tractors, boats, aircraft, bows, arrows, bullets, military vehicles, military equipment, cubes, cuboids, square based pyramids, cones, triangular prisms, triangular based pyramids, cylinders, spheres, rhombohedra, pentagonal prism, tetrahedron or other solid geometrical shapes. The background colorations include the natural colorations of the physical objects modeled and colorations which aid in concealment in specific environments. The three dimensional models sometimes overlap with or touch the other three dimensional models contained within the scene tangentially, and have a variety of different textures including texturing naturally found on the physical object being modeled including bark, leaves, fur, hair, skin, rocks, plants, grasses, bushes, metal, reeds, water, glass, plastics and fabrics. The textured surface can be smooth, rough, dimpled, furry, hairy, scaly, course, oily, sandy, polished, bumpy or fleshy. The three dimensional models assume any number of different arrangements, angles and placements in relation to the other three dimensional models contained within the digital three dimensional scene. Thus, the material is configured with embodiments of the pattern in accordance with the invention to create a scene which depicts a natural environment, physical objects or solid shapes which has a more realistic appearance than an illustrated, photographic or photographic based pattern. The field of depth is adjusted by changing the focal length of the rendered image, rather than utilizing layers and perspective as in photographic based patterns. Embodiments of the inventions also provide methods of making a camouflage pattern and camouflage material, including transfer of the pattern to a substrate.

Other advantages and better appreciation of the specific adaptations, variations, and physical attributes of the invention will be gained upon an examination of the following detailed description of the invention, taken in conjunction with the accompanying drawings.

### BRIEF DESCRIPTION OF THE DRAWINGS

FIG. 1 is an illustration of a mesh three dimensional model of one preferred embodiment of a natural three dimensional modeled element.

FIG. 2A is an illustration of a cut-away three dimensional model of one preferred embodiment of a natural three dimensional modeled element showing partially the mesh polygon structure and partially the texture skin applied to the mesh structure.

FIG. 2B is an illustration of the fully textured or skinned three dimensional model of one preferred embodiment of a natural three dimensional modeled element.

FIG. 3A is an illustration of a mesh wire frame three dimensional model of one preferred embodiment of a non-natural three dimensional sphere shape.

FIG. 3B is an illustration of a fully textured three dimensional model of one preferred embodiment of a non-natural three dimensional sphere shape.

FIG. 4 is a line drawing of a scene in which three dimensional models have been placed at various depths within the scene.

FIG. 5 is a sample of the two dimensional rendered pattern in accordance with the invention;

FIG. 6 is an illustration of the rendering of a pattern repeated;

FIG. 7 is a flowchart of a method of the creation and artistic design of a three dimensional model in accordance with the invention;

FIG. 8 is a flowchart containing an overview of a method of creating a pattern in accordance with the invention;

FIG. 9 is an illustration of an exemplary embodiment of a pattern using three dimensional models based upon natural objects in accordance with the invention;

FIG. 10 is a front view of an exemplary embodiment of a pattern using three dimensional models based upon solid geometrical shapes in accordance with the invention;

FIG. 11 is a front plan view of an article of manufacture including a pattern of an embodiment in accordance with the invention; and

FIG. 12 is a front plan view on an article of manufacture including a pattern of an embodiment in accordance with the invention.

### DETAILED DESCRIPTION OF THE PREFERRED EMBODIMENTS

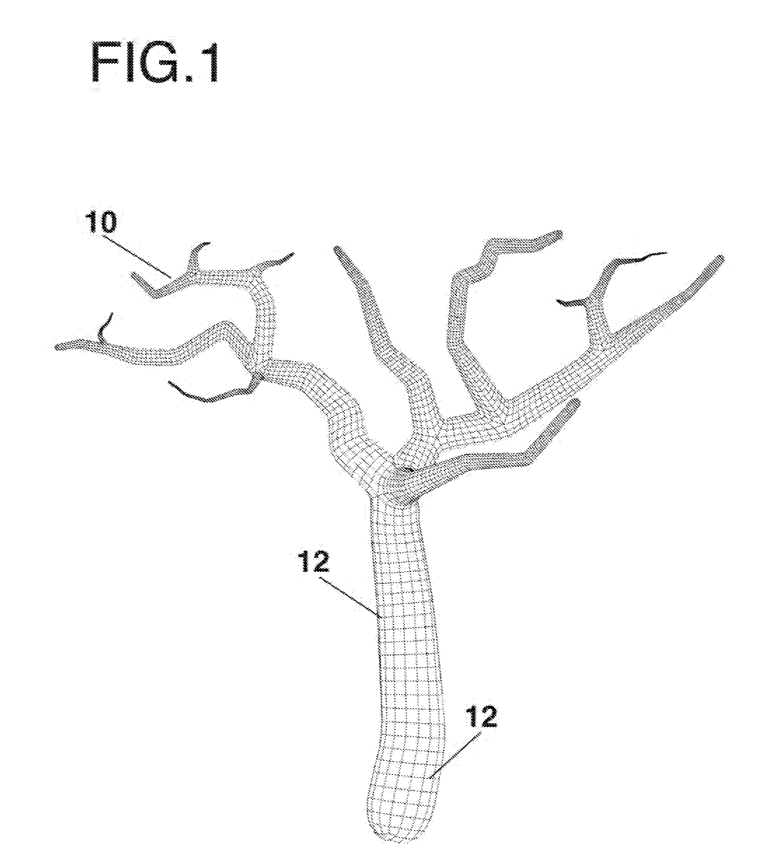

With reference to the drawings represented in FIGS. 1 through 12, a new article of camouflage with a realistic three dimensional appearance with a presentation more realistic than a photograph or photographic based image and the method of making such camouflage articles embodying the system, principals and concepts of the present invention will be described.

It will be readily understood to those of ordinary skill in the art that the components of the present invention, as generally described and illustrated in the Figures herein, could be arraigned and designed in a wide variety of different configurations. Thus the following more detailed description of the embodiments of the system and method of the present invention, are represented in FIGS. 1 through 13, is not intended to limit the scope of the invention.

FIG. 1 shows a mathematical representation of the structure of a solid object 10 of one preferred embodiment in a digital wire mesh form. The illustrated object 10 in this preferred embodiment is the digital wire mesh structural depiction of a tree. The mathematical digital wire mesh model is created by specifying each edge of the physical object where two mathematically continuous smooth surfaces meet 12. The resulting digital wire frame mesh provides a digital three dimensional model of the structure of a solid object. The digital wire mesh frame can be created manually using a programmed computer to sculpt the object, for example in Pixologic ZBrush4.0® or Daz3D Carrara®. The digital wire mesh frame can also be created by utilizing an apparatus to scan a physical object utilizing contact, non-contact active, time-of-flight, triangulation, conoscopic holography, hand-held laser, structured light, modulated light, stereoscopic, photometric or silhouette scanning. The digital wire mesh frame can be created utilizing software in a programmed computer which takes a digital scanned two dimensional image and creates an approximate three dimensional digital wire mesh frame. The wire mesh frame can also be selected from a data base containing already created wire mesh models.

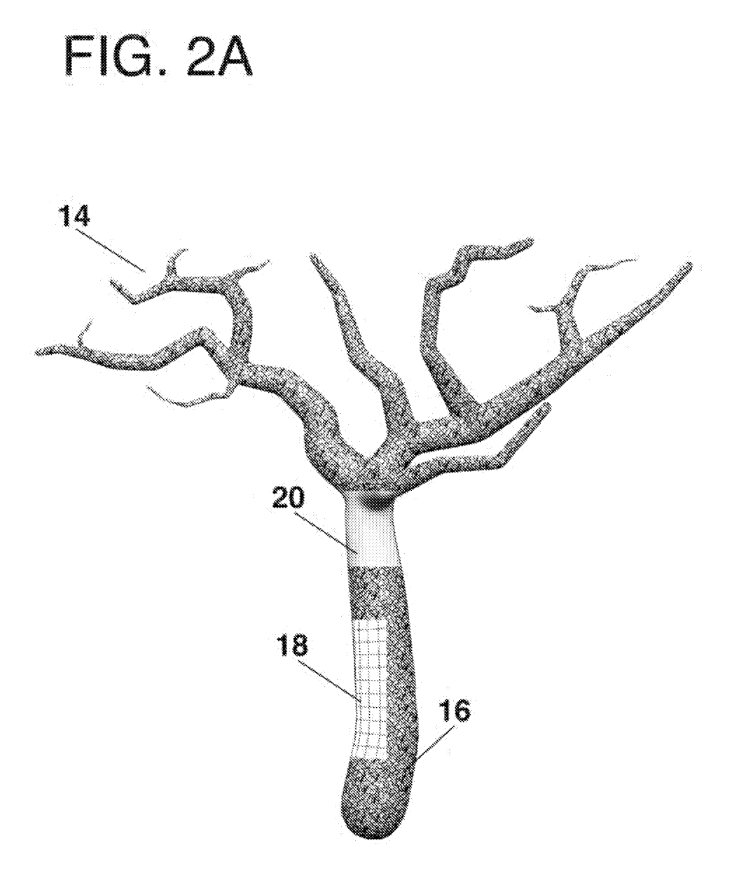

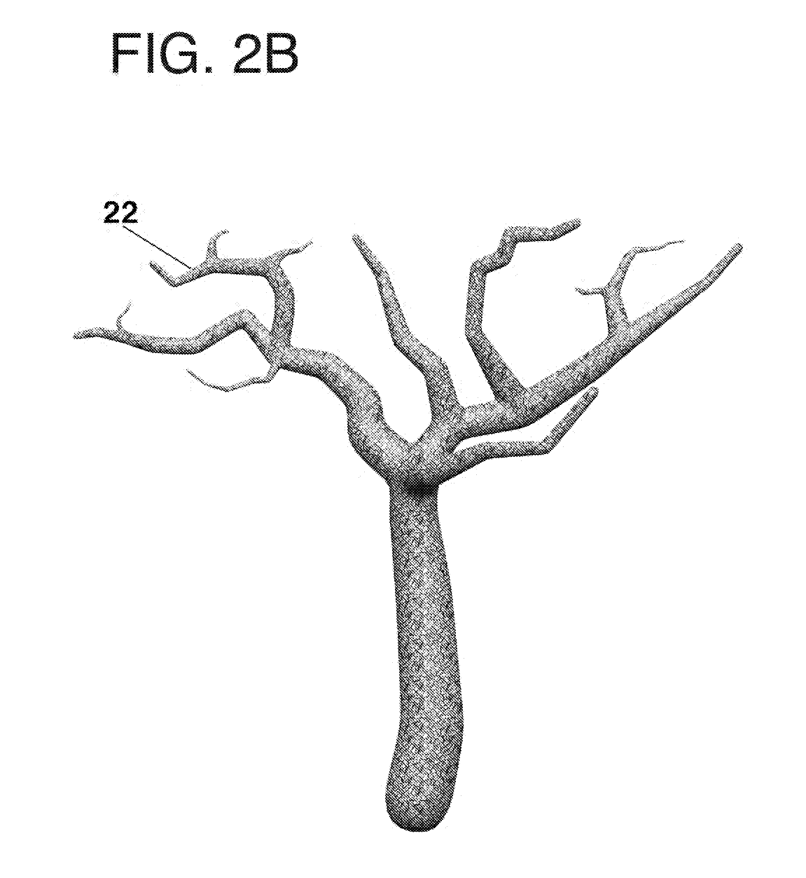

FIG. 2A shows a digital mathematical representation of a natural object 14 with surface texturing 16 applied and a cut away view showing the underlying wire frame mesh 18. Once the digital wire frame mesh of the structure of the object is created from FIG. 1, a surface texture 16 can be applied to the wire mesh frame to create a three dimensional digital representation of a solid object. The surface texture is a highly detailed representation of the surface of the solid object being modeled. In this illustration the surface texture 16 is a highly detailed representation of the surface of a tree. The surface texture can be modeled in a single neutral color while sculpting the digital three dimensional object in order to view the detail and contrast of the surface texture 20. The surface texture can also be colored to include colorations that are natural colors of the solid object being modeled, primary or non-primary colors. In this illustration the surface texture contains colors typically occurring in a tree including browns, tans, greens and black. In one embodiment the surface texture can be created by manually using a programmed computer to texture the object, for example in Pixologic ZBrush 4.0® or Daz3D Carrara®. In another embodiment the texture can be created by utilizing an apparatus to scan a physical object utilizing contact, non-contact active, time-of-flight, triangulation, conoscopic holography, hand-held laser, structured light, modulated light, stereoscopic, photometric or silhouette scanning. In another embodiment can be created utilizing software in a programmed computer which takes a digital scanned two dimensional image and creates an approximate three dimensional surface texture. In another embodiment the texture of the object can be selected from a database containing pre-created textured three dimensional models.

FIG. 2B shows a digital mathematical representation of a solid shape with a textured surface 16 applied to the entire object, to show a preferred embodiment of a completed digital three dimensional model. The completed, textured digital three dimensional models form the elements which will be arraigned into a digital three dimensional scene to create a camouflage pattern. The completed digital three dimensional scene will consist of a plurality of digital three dimensional models of objects including but not limited to trees, branches, leaves, rocks, grasses, plants, bushes, shrubs, ferns, reeds, water, wildlife, deer, turkeys, elk, moose, hogs, ducks, geese, fish, skulls, antlers, bones firearms, vehicles, tractors, boats, aircraft, bows, arrows, bullets, military vehicles, military equipment, cubes, cuboids, square based pyramids, cones, triangular prisms, triangular based pyramids, cylinders, spheres, rhombohedra, pentagonal prism, tetrahedron or other solid geometrical shapes. The resulting digital three dimensional model will accurately create a digital three dimensional representation of a solid object. The textured surface of the digital three dimensional model accurately represents the surface of a physical object to the extent that shadows, lighting and depth can be applied in accordance to the physical world. When a digital three dimensional model is rendered into a two dimensional image using the aid of a programmed computer, the resulting two dimensional images are of a definition, clarity and focus that give a more realistic appearance than an illustrated, photographic and photographic based image. In some instances the light, shadow and texture of a rendered two dimensional image can be indistinguishable from reality. The Rendered two dimensional images contain none of the hyper reflections or distortions of a photographic based image. Rendered digital three dimensional objects placed within a scene also allow for the accurate application of a single or multiple source of light and the resulting shadows are accurately represented as they would occur in the physical world. Rendered digital three dimensional objects are also of infinite resolution, so that the rendered two dimensional image can be rendered in any size without a resulting loss of clarity and focus as with a photograph or photographic based image. The rendered two dimensional image will not become grainy looking when rendered in a larger size a photographic or photographic based images do.

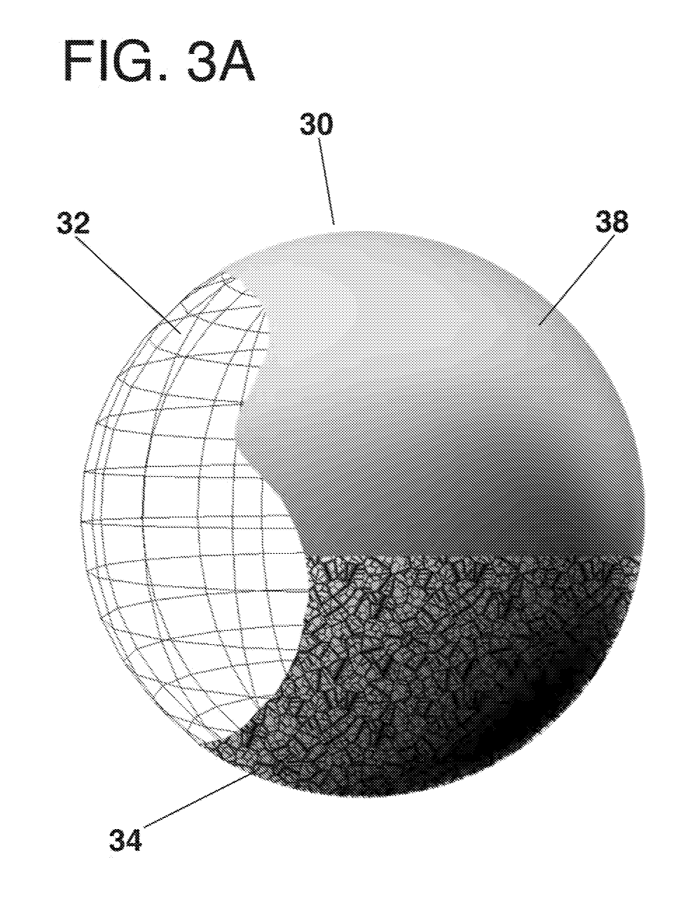

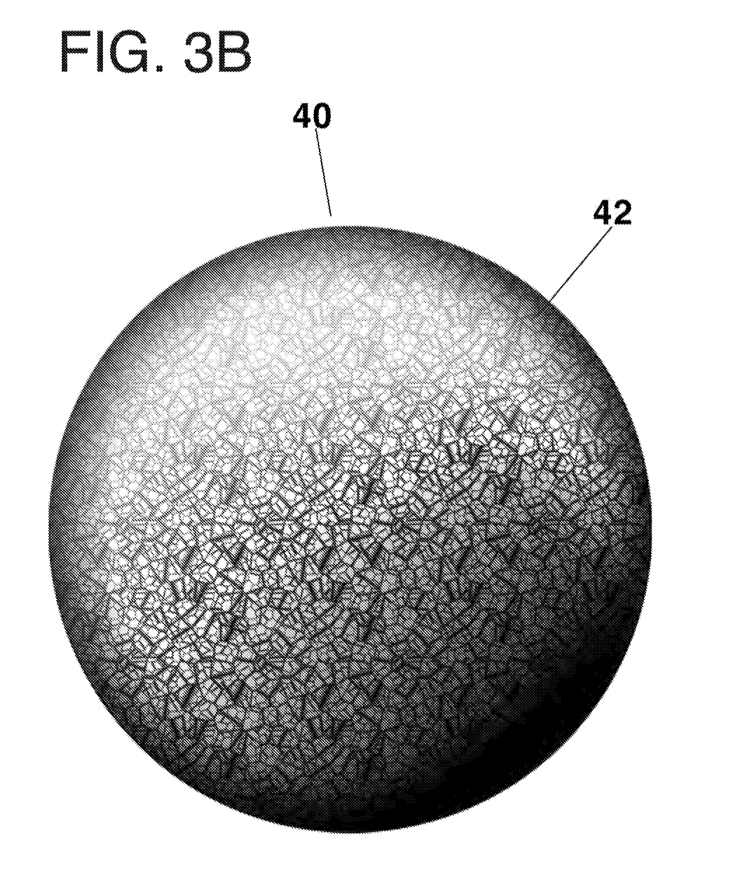

FIG. 3A shows a digital mathematical representation of an non-natural three dimensional solid shape 30 with surface texturing applied and a cut away view showing the underlying wire frame mesh 32. Once the wire frame mesh of the structure of the object is created from FIG. 1, a textured surface 34 can be applied over the wire frame mesh 32 to create a solid digital object. The surface texture creates a highly detailed representation of the physical surface of the object being modeled. In this illustration the surface texture 34 is a highly detailed representation of a smooth surface. The textured surface can be modeled in a single neutral color while sculpting the digital three dimensional object in order to view the detail and contrast 38. The textured surface can also be colored to include colorations that are natural colors of the solid object being modeled, primary or non-primary colors. In this illustration the textured surface contains a green coloration. In one embodiment the surface texture can be created by manually using software in a programmed computer to texture the object, for example Pixologic ZBrush 4.0® or Daz3D Carrara®. In another embodiment the surface texture can be created by utilizing an apparatus to scan a physical object utilizing contact, non-contact active, time-of-flight, triangulation, conoscopic holography, hand-held laser, structured light, modulated light, stereoscopic, photometric or silhouette scanning. In another embodiment the surface texture can be created utilizing software in a programmed computer which takes a digital scanned two dimensional image and creates an approximate three dimensional surface texture. In another embodiment the surface texture of the object can be selected from a database containing pre-created textured digital three dimensional models.

FIG. 3B shows a digital mathematical representation of an non-natural three dimensional solid shape 30 with surface texturing 34 applied to the entire object, to show a preferred embodiment of a completed digital three dimensional model. The completed, fully surface textured models form the elements which will be arraigned into a digital three dimensional scene to create a camouflage pattern. The completed digital three dimensional scene will consist of a plurality of digital three dimensional models of objects including but not limited to trees, branches, leaves, rocks, grasses, plants, bushes, shrubs, ferns, reeds, water, wildlife, deer, turkeys, elk, moose, hogs, ducks, geese, fish, skulls, antlers, bones firearms, vehicles, tractors, boats, aircraft, bows, arrows, bullets, military vehicles, military equipment, cubes, cuboids, square based pyramids, cones, triangular prisms, triangular based pyramids, cylinders, spheres, rhombohedra, pentagonal prism, tetrahedron or other solid geometrical shapes. The resulting digital three dimensional model will accurately create a digital three dimensional representation of a solid object. The surface texture of the three dimensional model accurately represents the surface of a physical object to the extent that shadows, lighting and depth can be applied in accordance to the physical world When a digital three dimensional model is rendered into a two dimensional image using the aid of a programmed computer, the resulting two dimensional images are of a definition, clarity and focus that give a more realistic appearance than an illustrated, photographic and photographic based image. In some instances the light, shadow and texture of a rendered two dimensional image can be indistinguishable from reality.

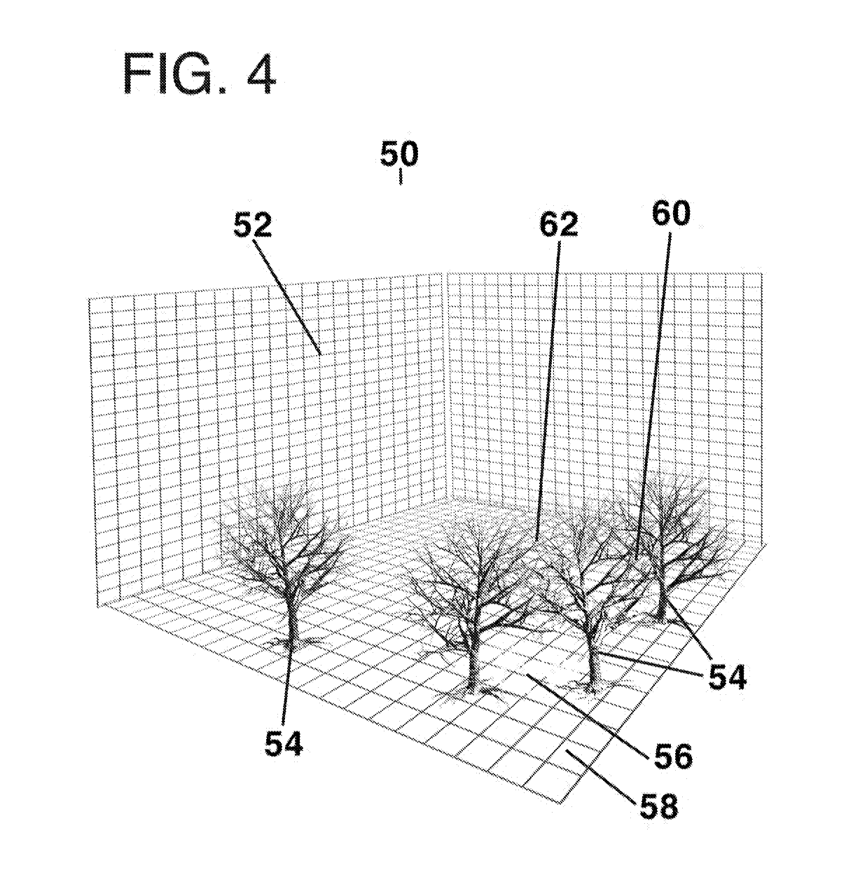

FIG. 4 shows a digital three dimensional scene 40 which resides in a programmed computer, in which a plurality of digital three dimensional models has been placed. The scene 40 included a background. 42 The background contains coloration of natural colors of the environment of the scene or the coloration of the blurred physical objects being modeled including but not limited to brown, gray, tan, black or green. Throughout the digital three dimensional scene digital three dimensional models 44 have been placed at varying depths, including the mid-ground 46 and foreground 48. The digital three dimensional models 44 in FIG. 4 consist of natural elements including trees, branches, leaves and plants. The digital three dimensional models 44 assume any number of different arrangements or positions in relation to each other. Sometimes the digital three dimensional models overlap or touch each other tangentially. The scene 40 is arraigned to simulate a natural area of woodlands, grasslands, desert, mountains, geometrical shapes or physical objects arraigned and with coloration to conceal the object or wearer. In at least one embodiment according to the invention, the digital three dimensional models 44 of physical objects or solid shapes such to trees, branches, leaves, rocks, grasses, plants, bushes, shrubs, ferns, reeds, water, wildlife, deer, turkeys, elk, moose, hogs, ducks, geese, fish, skulls, antlers, bones firearms, vehicles, tractors, boats, aircraft, bows, arrows, bullets, military vehicles, military equipment, cubes, cuboids, square based pyramids, cones, triangular prisms, triangular based pyramids, cylinders, spheres, rhombohedra, pentagonal prism, tetrahedron or other solid geometrical shapes can be places in varying depths and positions within the digital three dimensional scene. The digital three dimensional models 44 assume any number of different arrangements or positions in relation to each other. Sometimes the digital three dimensional models overlap 50 or touch each other tangentially 52. The digital three dimensional model's coloration includes coloration that are natural colors of the physical object modeled, plants, animals, fowl and the environment or primary and non-primary colors. These colors can include brown, tan, green, gray, black, blue, yellow, orange, red and other colors.

Once the digital three dimensional models are placed within the digital three dimensional scene, the scene can be manipulated with the aid of a programmed computer to adjust the reflection/scattering of light including but not limited to the application of flat shading, Gouraud shading, texture mapping, Phong shading, Bump mapping or Cel shading. The three dimensional digital scene can also be manipulated with the aid of a programmed computer to apply ray tracing to accurately portray lighting effects such as absorption, reflection, refraction and fluorescence. The digital three dimensional scene can also be manipulated with the aid of a programmed computer to apply radiosity, a rendering algorithm which accurately portrays shadows and diffuse light. The digital three dimensional scene can also be manipulated with the aid of a programmed computer to apply transport; accurately portraying how the illumination from the light source gets to the digital three dimensional models placed within the scene. The three dimensional digital scene can also be manipulated with the aid of a programmed computer to apply global lighting including but not limited to an individual or plurality of algorithms such as radiosity, ray tracing, beam tracing, cone tracing, path tracing, Metropolis light transport, ambient occlusion, photon mapping and image based lighting. Techniques and effects can also be applied to the three dimensional scene with the aid of a programmed computer for the purpose of simulating naturally-occurring effects. These techniques include particle systems which simulate the natural visual effects of rain, smoke or fire. Volumetric sampling can be applied which simulates the natural visual effects of fog, dust, or other spatial atmospheric effects. Caustics can be applied which simulates the natural visual effect of light focusing by uneven light-refracting surfaces, such as the light ripples appearing at the bottom of a swimming pool. Subsurface scattering can be applied to simulate the natural visual effect of light reflecting inside the volumes of solid objects such as human skin. The advantages of the invention will be readily apparent to those skilled in the art. The application of light and shadow to a coherent scene will create an accurate depiction of light, transport, shading and shadows.

Once the three dimensional models are placed and positioned in the digital scene and the effect or effects of lighting, shadow, absorption, reflection, refraction, florescence and transport are applied the resulting digital three dimensional scene is a high definition, realistic appearing scene with realistic lighting and shading with a realistic three dimensional appearance. The scene is of infinite resolution and can be enlarged or miniaturized to any size without losing focus, clarity or definition. Someone skilled in the art can create a digital three dimensional scene which is visually indistinguishable from reality. After one or more of the effects have been applied to the three dimensional scene it can be saved in digital form. The digital data set can then be converted through the aid of a programmed computer into a two dimensional image through the process called rendering. The rendered two dimensional image can be saved in digital form and can be used by a variety of printing methods to print the pattern on a substrate.

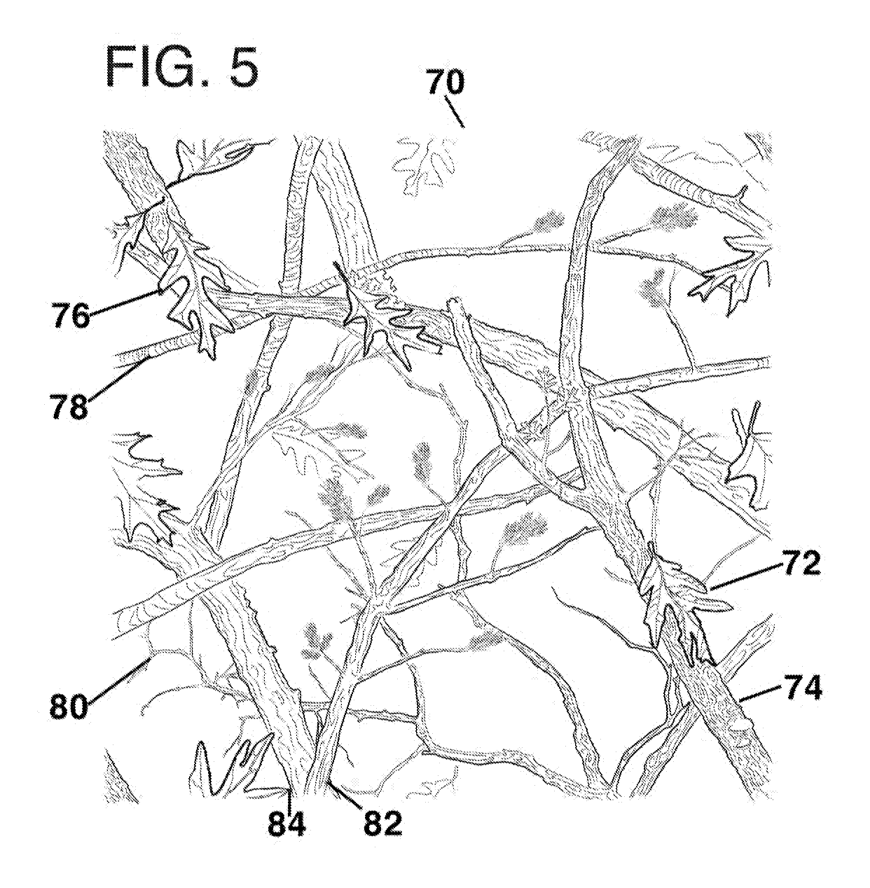

FIG. 5 illustrates a rendered three dimensional camouflage pattern according to one embodiment of the invention as shown 60. FIG. 5 illustrates an exemplary embodiment of the principles embodying camouflage system 60. After the digital three dimensional models have been arranged in a digital three dimensional scene and the lighting, shadow, absorption, reflection, refraction and florescence has been applied through the aid of a programmed computer; the digital three dimensional scene can be rendered into a digital two dimensional image. Rendering is the process of utilizing a programmed computer to automatically convert a digital three dimensional scene into a two dimensional image with realistic three dimensional lighting, shading, natural effects and perspective. When the image is rendered, the focal length of the image can be adjusted to give the image a blurred appearance in the background, mid-ground, foreground or any combination of the three. By adjusting the focal length to blur areas of the rendered two dimensional image, the resulting two dimensional image will realistically mimic the focus and perception of a human or animal eye. The rendered image will also have realistic application of light, transport, shading and shadow giving the rendered two dimensional image a three dimensional appearance. By utilizing the system of the invention, one skilled in the art could create a rendered pattern with a three dimensional appearance without the need of having elements contained within the pattern overlap as in a photographic based pattern. The resulting rendered two dimensional image can be displayed on a computer screen, printed, or saved in digital form for transmission and use by a variety of printing methods to print the pattern on a substrate. The resulting rendered image is the basis for the camouflage pattern in one embodiment of the invention. The rendered two dimensional image can also be repeated to make a larger camouflage pattern.

The system of the invention may include a plurality of objects which rendered into a two dimensional image creates a pattern. The pattern may include a plurality of digital three dimensional models 62 with a fully textured surface 64 placed at various depths into the scene (see, e.g. FIG. 4) including into the foreground, 66 mid-ground, 68 and background 70 of the scene. The pattern consists of a two dimensional rendered image of the digital three dimensional scene. The digital three dimensional scene consists of an individual or plurality of digital three dimensional models placed at varying depths into the scene. The digital three dimensional models 62 consist of natural elements including trees, branches, leaves, rocks, grasses, plants, bushes, shrubs, ferns, reeds, water, wildlife, deer, turkeys, elk, moose, hogs, ducks, geese, fish, skulls, antlers and bones. The digital three dimensional models 62 assume any number of different arrangements or positions in relation to each other. Sometimes the digital three dimensional models overlap 72 or touch each other tangentially 74. The digital three dimensional model's coloration includes colorations that are natural colors of the physical object modeled, plants, animals, fowl and the environment or primary and non-primary colors. These colors can include brown, tan, green, gray, black, blue, yellow, orange, red and other colors found in a natural environment.

In embodiments in accordance with the invention, the combination of solid digital three dimensional models placed at various depths in the scene and the application of accurate lighting, shadow, absorption, reflection, refraction and florescence may increase the three dimensional perception, depth and visual effect in comparison to manually illustrated, photographic or photographic based camouflage patterns. Using the system of the invention, those skilled in the art can create a rendered two dimensional image with such accurate textured surfaces, lighting, shadow, absorption, reflection and florescence that the image is indistinguishable from reality.

Additionally, in at least one embodiment, the use of camouflage system 60 the resolution of the rendered two dimensional image may be of a higher and sharper resolution of manually illustrated, photographic, pixelated, or photographic based camouflage patterns. The camouflage system 60 allows for the realistic application of light, shading and shadow from a single or multiple sources onto the three dimensional scene. In one embodiment of the camouflage system 60, the ability to realistically apply light, shading and shadow to the three dimensional scene allows for a pattern more realistic than illustrated, photographic or photographic based camouflage patterns. Illustrated, photographic and photographically based patterns are limited by the use of multiple elements which contain different and conflicting light and shadow. Photographic, photographically based and illustrated patterns are further limited by the inclusion of artistically inserted shading and shadows, which are limited by the subjective interpretation of the artist. The use of camouflage system 60 is also of infinite resolution which allows the pattern to be enlarged or shrunk to any size without a loss of resolution, definition or focus which occurs in realistic photographic or photographic based camouflage patterns. The rendered two dimensional image can be enlarged without the grainy appearance that occurs when a photograph or photographic based image is enlarged. In at least one embodiment the use of camouflage system 60 results in camouflage patterns which have a more realistic visual effect than manually illustrated, pixilated, photographic or photographic based camouflage patterns. The camouflage system 60 rendering results in a pattern that can be reproduced in a larger size and applied to any substrate through use of a suitable image transferring method.

There are several image transfer system known in the art which can reproduce the high resolution rendered two dimensional image. The specific method of image transfer may vary depending on the substrate to which the image is to be transferred. Methods in use in the art include silk screening, ink jet printing, digital fabric printing, engraving, heat transfer papers, dye sublimation, wet transfer process, wet transfer plate method, etc. Some methods of image transfer include an image transfer medium where the image is printed, and then transferred to a substrate. For hard goods, which may include bows, firearms, all terrain vehicles panels, automobile trim, boxes, cases, crossbows and other goods with a hard surface there are several methods. These methods include a wet transfer method, or hydro dipping, where a digital image of the pattern is printed on a specialized film. The film is activated with water, and the hard good item is dipped into the film in a water tank. The film will adhere to complex three dimensional objects, coating them with a high quality reproduction of the image. Another such method is the use of roller screens to which particular colors of ink adhere. The substrate is run through the rollers which each apply a primary color or combination of primary colors to create non-primary colors. Once each primary color plate image is transferred to the substrate, the resulting image is a high quality reproduction of the pattern. The appropriate image transfer process depends on the substrate to which the pattern is transferred. When transferring the pattern to a substrate, an appropriate method will be used in accordance with embodiments of the invention.

At least one embodiment according to the invention includes a system and method of creating a camouflage pattern. The pattern 76 can be composed or created from a rendered two dimensional image of a digital three dimensional scene containing a plurality of digital three dimensional models. The digital three dimensional models can be created through manual sculpting a wire mesh model with the aid of a programmed computer and software, scanned from a physical object, created by software from a scanned two dimensional image or selected from a database of pre-created digital three dimensional models. A textured surface will then be applied to the digital three dimensional wire frame mesh model to give the object a solid appearance, and accurately recreate the surface qualities of the physical object. The digital three dimensional models consist of but are not limited to trees, branches, leaves, rocks, grasses, plants, bushes, shrubs, ferns, reeds, water, wildlife, deer, turkeys, elk, moose, hogs, ducks, geese, fish, skulls, antlers, bones, firearms, vehicles, tractors, boats, aircraft, bows, arrows, bullets, military vehicles, military equipment, cubes, cuboids, square based pyramids, cones, triangular prisms, triangular based pyramids, cylinders, spheres, rhombohedra, pentagonal prism, tetrahedron or other solid geometrical shapes The digital three dimensional models may then be placed within a digital three dimensional scene which resides within a programmed computer. The digital three dimensional models may be placed at varying depths in the scene including the foreground, midground and background. The coloration of the digital three dimensional models and background can consist of natural colors of the physical object modeled, the environment, primary or non-primary colors. The digital three dimensional scene will also have effects applied through the use of a programmed computer including accurate lighting, shadow, absorption, reflection, refraction and florescence. Once the scene is completed, the digital three dimensional scene can be rendered into a two dimensional image through the use of a programmed computer. The scene can be rendered to a computer screen, onto a substrate through a printer or saved as a digital data set. During the rendering process, the depth of field and focal plane can be manipulated through the use of programmed computer to blur certain areas of the scene. The resulting blurring of certain parts of the image results in a camouflage pattern which mimics the perception of the human or animal eye. The rendered two dimensional image can be saved in a digital format to be transmitted for use by an appropriate printing system. In at least one embodiment, the method includes printing, applying or transferring the pattern on to an article of manufacture.

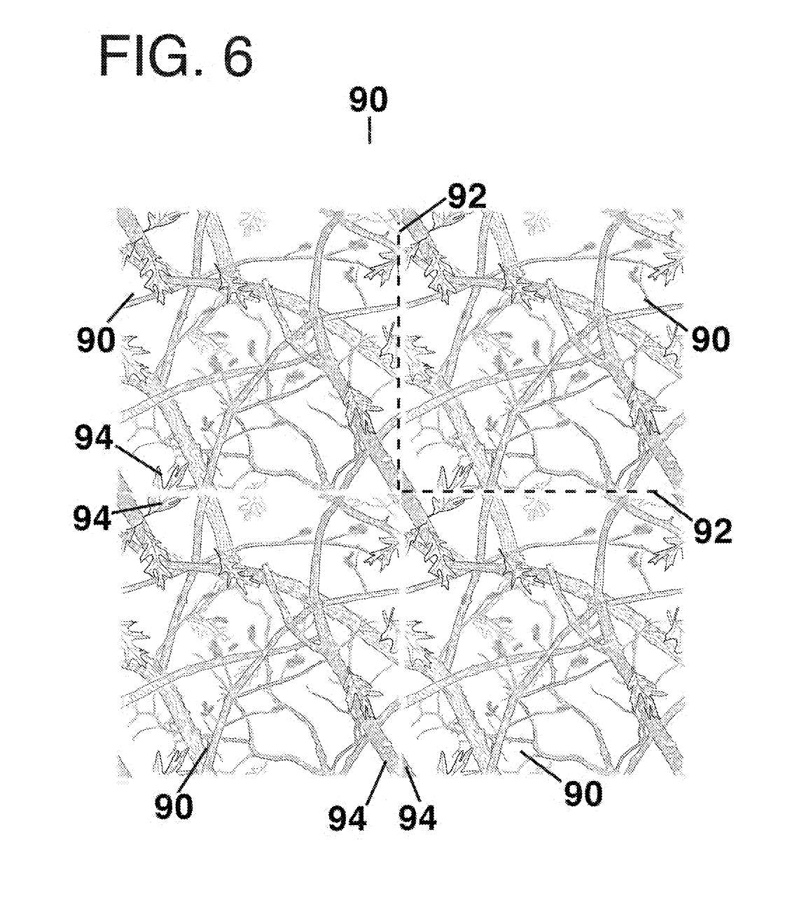

FIG. 6 is an illustration of the pattern repeated. In at least one embodiment according to the invention the use of the method or system allows for the creation of patterns of a lager size than photography or photographically based patterns. The pattern 80 will still require the use of repetition by placing several patterns 82 adjacent to each other 84. In at least one embodiment the pattern may be designed so that its edge elements 86 are symmetrical so that when the patterns are placed adjacently they create a seamlessly repeated pattern 80. In at least one embodiment in accordance with the invention the seamless, repeated pattern may be transferred to a substrate through the use of several methods of image transfer suitable for a particular substrate known to the art including silk screening, ink jet printing, digital fabric printing, engraving, heat transfer papers, dye sublimation, wet transfer process, wet transfer plate method, etc.

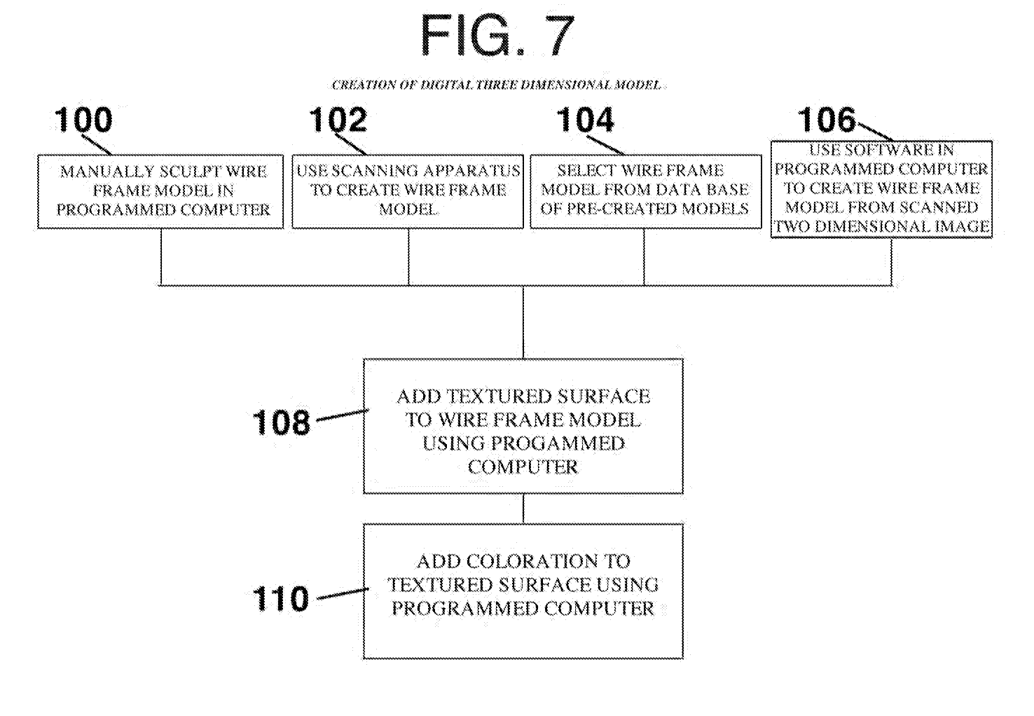

FIG. 7 is a flowchart showing each step in the creation of a digital three dimensional model in accordance with the invention. Steps one through four exemplify the plurality of methods which can be used to create the digital wire frame model of the structure of the object being modeled. Step one 90 shows the creation of a digital wire frame model of the structure of the object being modeled by manually sculpting the model through the use of software in a programmed computer. Step two 92 shows the creation of a digital wire frame model through the use of a scanning apparatus known in the art. Step three 94 shows the selection of a digital three dimensional wire frame model from a database of pre-created digital three dimensional models. Step four 96 shows the creation of a digital wire frame model through the use of software in a programmed computer to create a digital three dimensional wire frame model from a scanned, digital two dimensional image. Step five 98 shows the application of a textured solid surface through the aid of a programmed computer to the digital three dimensional wire frame model. A digital three dimensional wire frame model selected from a database of pre-created digital three dimensional models may have a pre-created textured solid surface applied. A digital three dimensional wire-frame model created by software in a programmed computer from a scanned, digital two dimensional image may also create a textured solid surface. Step six 100 shows the application of coloration to the surface texture of a digital three dimensional model using primary or non-primary colors.

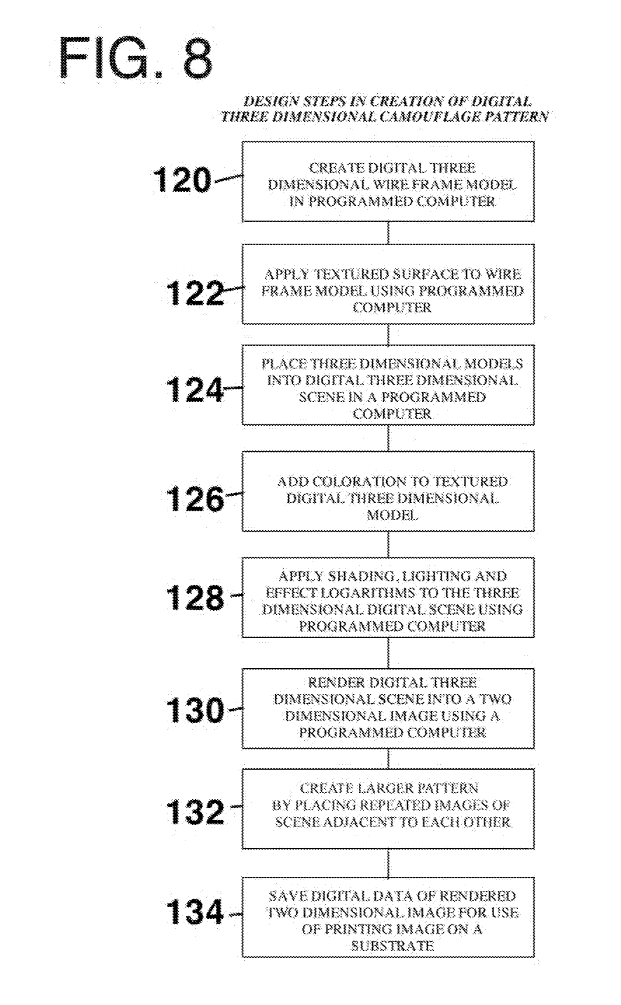

FIG. 8 is a flowchart showing each step of the creation of the design of camouflage in accordance with the system of the invention. The first step 110 in the method of creating a camouflage pattern in accordance with the invention is the creation of a digital wire frame of the structure of a physical object. The digital three dimensional wire frame model can be created by manual sculpting the object with the use of a programmed computer, scanning a physical object with a scanning apparatus known in the art, selecting a digital three dimensional wire frame model from a database of pre-created digital three dimensional wire frame models or utilizing software in a programmed computer to create a digital three dimensional wire frame model from a scanned, digital two dimensional image.

The second step 112 in the method of creating a camouflage pattern in accordance with the invention is using a programmed computer to apply a textured solid surface to the digital three dimensional wire frame model.

The third step 114 in the method of creating a camouflage pattern in accordance with the invention is the placement of a plurality of completed, fully textured digital three dimensional models into a digital scene through the use of a programmed computer. The scene consists of a digital three dimensional space which resides within a programmed computer. Placement of the digital three dimensional models within the scene by a designer is done with an objective to maximize the scene's and resulting rendered pattern's ability to break up the human or object's form to which the pattern is applied, the patterns ability to blend into one or a plurality of natural environments and the use of depth through three dimensional effects to maximize the break-up and blend abilities of the pattern.

The fourth step 116 in the method of creating a camouflage pattern in accordance with the invention is the addition of coloration to the digital three dimensional models and background of the scene. The coloration includes colorations that are natural colors of the physical object modeled, natural elements, animals, fowl, the environment, primary and non-primary colors.

The fifth step 118 in the method of creating a camouflage pattern in accordance with the invention is the application of a single or plurality of effects or logarithms which can be applied to the textured surface of the three dimensional models, lighting and shadow of a scene through the use of a programmed computer, including but not limited to ray tracing, absorption, reflection, refraction and fluorescence, radiosity, transport, global illumination cone tracing, path tracing, Metropolis light transport, ambient occlusion, photon mapping, image based lighting, flat shading, Gouraud shading, texture mapping, Phong shading, Bump mapping or Cel shading. Lighting and shadow can be applied the the three dimensional scene accurate to reality form a single or multiple sources of light. It is anticipated that further methods or algorithms will be created so that one skilled in the art could apply them to a scene to increase the realism of the resulting camouflage pattern in accordance with the invention.

The sixth step 120 in the method of creating a camouflage pattern in accordance with the invention is to utilize software to automatically convert the digital three dimensional scene into a digital two dimensional file or image through the use of a programmed computer in a process known as rendering.

The seventh step 122 in the method of creating a camouflage pattern in accordance with the invention is to create a larger pattern through the placement of repeated images of the rendered scene adjacent to each other.

The eighth step 124 in the method of creating a camouflage pattern in accordance with the invention is to save the rendered two dimensional image into a digital data set which can be transmitted to a manufacturer for the use of printing on a substrate for use in manufactured goods.

????

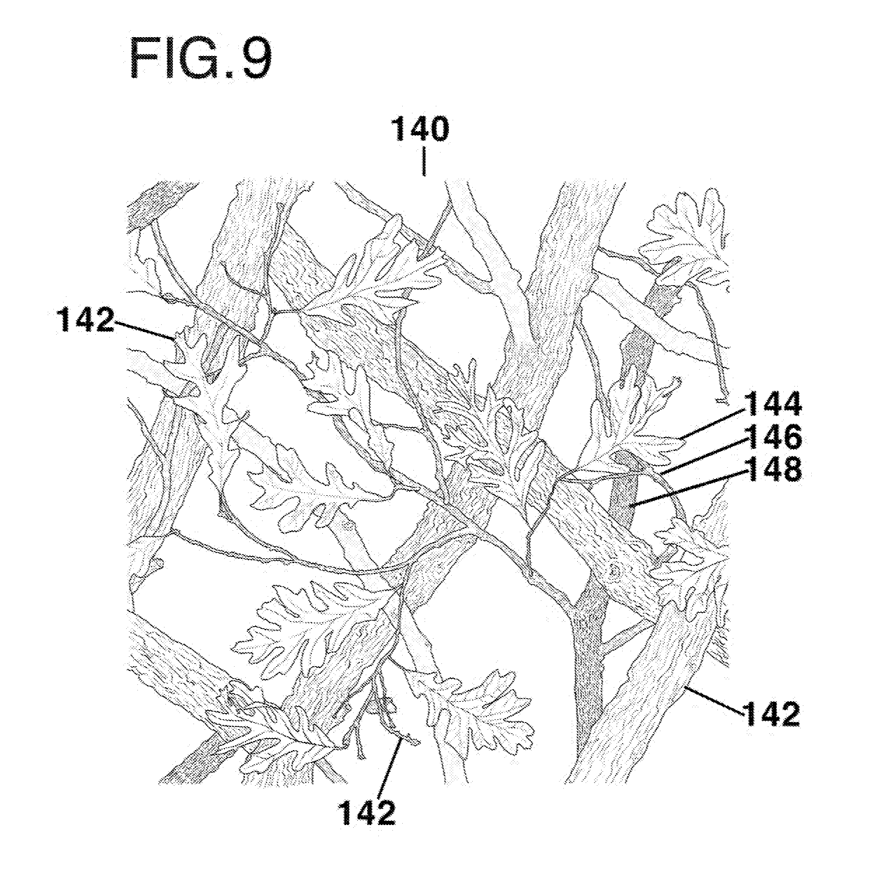

FIG. 9 depicts an illustration of an exemplary rendered camouflage pattern or system according to at least one embodiment. As illustrated, camouflage system 130 includes a plurality of three dimensional models 132 of trees, leaves, evergreen needles, bark and lichens placed at varying depths including in the foreground 134 mid-ground 136 and background 138. Foreground 134, mid-ground 136, and background 138 are illustrative of the natural environment of mixed hardwood forest and includes a plurality of pines placed at varying depths. The background of the rendered camouflage pattern consists of a blurred image of the three dimensional models typical to the camouflage pattern. Because the three dimensional models 122 are placed continuously throughout the scene, the focal length of the rendered image can be changed to manipulate the appearance of the depth of the foreground 134, mid-ground 136 and background 138. This results in a superior and more realistic image than a photographic based pattern where depth is created by layering the foreground, mid-ground and background and through the use of perspective.

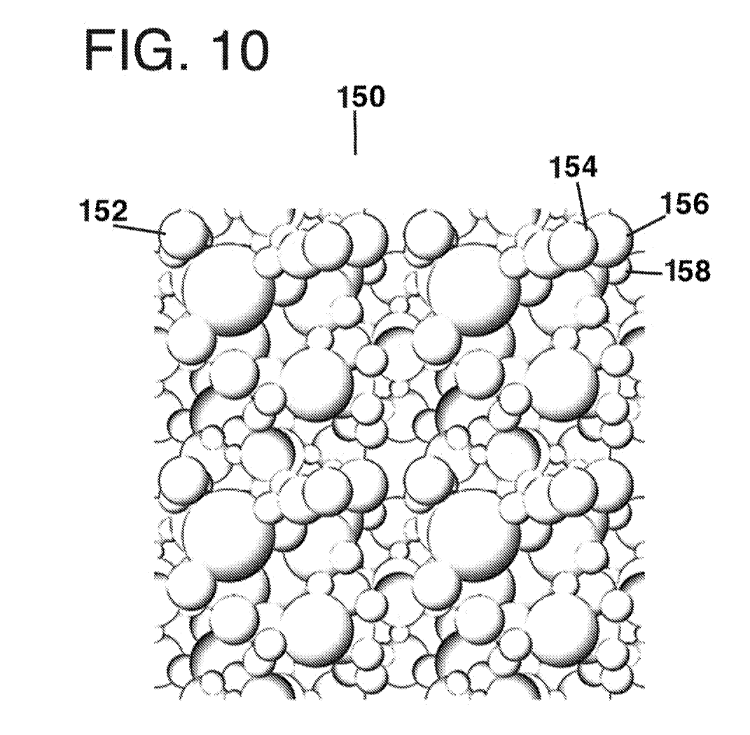

FIG. 10 depicts an illustration of an exemplary rendered camouflage pattern or system 140 according to at least another embodiment. As illustrated, camouflage system 140 includes a plurality of three dimensional models 142 of spheres placed at varying depths including in the foreground 144, mid-ground 146 and background 148. Foreground 144, mid-ground 146 and background 148 are illustrative of a pattern based upon solid shapes with a plurality of spheres with three dimensional effects placed at varying depths. The background 148 of the rendered camouflage pattern consists of a blurred image of the three dimensional models to simulate depth of field typical to the camouflage pattern.

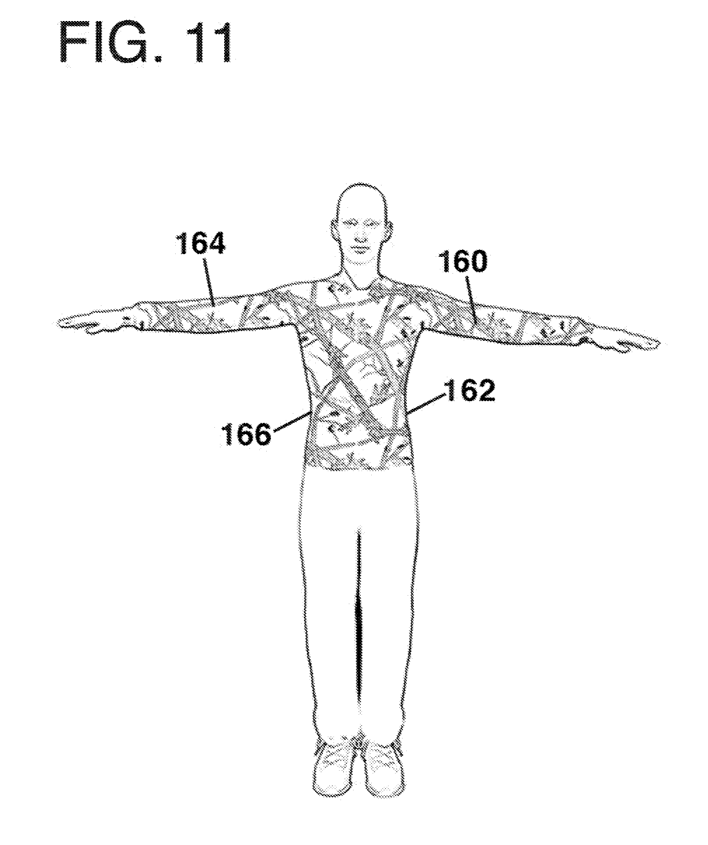

FIG. 11 illustrates an exemplary article of manufacture in which pattern 150 is used to construct therefore. FIG. 11 shows a jacket 152 which includes camouflage system 150. Jacket 152 may be of any type of jacket, e.g. work jacket, hunting jacket, duster, rain jacket, etc. Pattern may be incorporated into the entire jacket or may be placed on any portion 154 of the jacket 152. In one embodiment, pattern 150 may be suitably placed on the exterior surface 156 of jacket 152, and may visually conceal jacket 142 and the torso of the wearer. For example, the wearer may use the jacket 152 to conceal the wearer from animals in a natural environment in order to gain a closer proximity to an animal the wearer is hunting. A wearer of jacket 152 may be camouflaged or concealed when viewed in a natural environment in relatively close proximity, in relatively distant proximity, and any intermediate proximity in between.

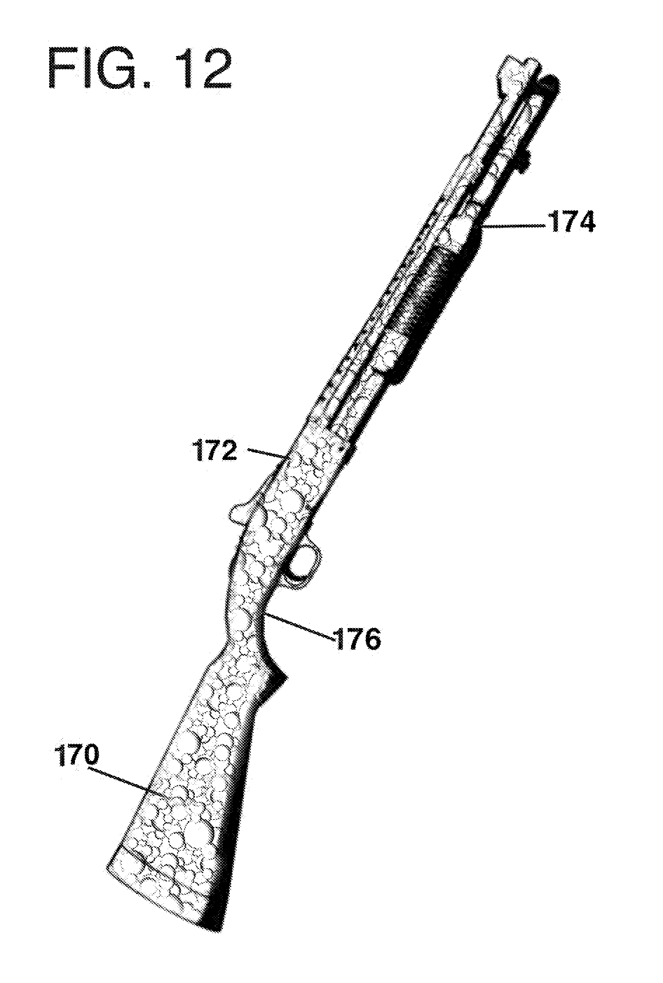

FIG. 12 illustrates an exemplary article of manufacture in which pattern 160 is used to construct therefore. FIG. 12 shows a rifle 162 which included camouflage system 160. The Rifle 162 may be any type of rifle, e.g. shotgun, semi-automatic, blackpowders, etc. Pattern may be incorporated onto the entire rifle or may be placed on any portion 164 of the rifle 162. In one embodiment, pattern 160 may be suitably placed on the exterior surface 166 of the rifle 162, and may visually conceal rifle 162. For example, the rifle 162 may be use the pattern 160 to conceal the rifle in a natural environment.

The foregoing descriptions of embodiments are solely of illustrative purpose to aid understanding of the principles apparent in the invention. Further embodiments and advantages may readily occur to those skilled in the art. The foregoing descriptions of embodiments are not desired to restrict the invention to the exact construction and operation shown and described, and accordingly, all appropriate modifications and equivalents are considered to fall within the scope of the invention. Various features and advantages of the invention are set forth in the appended claims and their equivalents.

What is claimed is:

1. An article of manufacture comprising:
a surface with a pattern comprising a realistic appearing two dimensional rendered image of a digital three-dimensional space having digital three dimensional models of physical objects or solid geometric shapes therein, the digital three dimensional models having a texture which accurately replicates the solid surface of a physical object,
the two dimensional rendered image having an appearance of realism greater than an illustrated, photograph or photographic based image,
the two dimensional rendered image having coloration and a plurality of digital three dimensional models of environmental elements, physical objects or geometric shapes placed at various depths which includes trees, branches, leaves, rocks, grasses, plants, bushes, shrubs, ferns, reeds, water, wildlife, deer, turkeys, elk, moose, hogs, ducks, geese, fish, skulls, antlers, bones, firearms, vehicles, tractors, boats, aircraft, bows, arrows, bullets, military vehicles, military equipment, cubes, cuboids, square based pyramids, cones, triangular prisms, triangular based pyramids, cylinders, spheres, rhombohedra, pentagonal prism, tetrahedron and combinations thereof,
the two dimensional rendering having realistic application of lighting, shadow, absorption, reflection, refraction, florescence and transport,
wherein the coloration in the two dimensional rendered image are the natural colors of the modeled animals, objects, the environment, primary, non-primary and neutral colors.

2. The article of claim 1, wherein the article is clothing, equipment, a vehicle or fabric.

3. The article of claim 1, further comprising an outer surface having the pattern applied thereon

4. The article of claim 1, wherein the two dimensional rendered image is a component image that is repeated throughout the surface of the article.

5. A camouflage pattern with a realistic appearance, comprising:
repeating two dimensional rendered images of a digital three-dimensional scene having digital three dimensional models therein,
the three dimensional models having a texture which accurately replicates the solid surface of the object being modeled,
the two dimensional rendered image having an appearance of realism greater than an illustrated, photograph or photographic based image,
the two dimensional rendered image having coloration and a plurality of digital three dimensional models of environmental elements, physical objects or geometric shapes placed at various depths within the scene which includes trees, branches, leaves, rocks, grasses, plants, bushes, shrubs, ferns, reeds, water, wildlife, deer, turkeys, elk, moose, hogs, ducks, geese, fish, skulls, antlers, bones, firearms, vehicles, tractors, boats, aircraft, bows, arrows, bullets, military vehicles, military equipment, cubes, cuboids, square based pyramids, cones, triangular prisms, triangular based pyramids, cylinders, spheres, rhombohedra, pentagonal prism, tetrahedron and combinations thereof,
the two dimensional rendering having realistic application of lighting, shadow, absorption, reflection, refraction, florescence and transport,
wherein the coloration in the two dimensional rendered image are the natural colors of the modeled animals, objects, the environment, primary, non-primary and neutral colors.

6. A method of making a camouflage pattern with an appearance of realism greater than an illustrated, photographic or photographic based patter, comprising:
creating or selecting, using a programmed computer, one or more digital three dimensional models stored in the computer, of environmental elements, physical objects or geometric shapes placed at various depths which includes trees, branches, leaves, rocks, grasses, plants, bushes, shrubs, ferns, reeds, water, wildlife, deer, turkeys, elk, moose, hogs, ducks, geese, fish, skulls, antlers, bones, firearms, vehicles, tractors, boats, aircraft, bows, arrows, bullets, military vehicles, military equipment, cubes, cuboids, square based pyramids, cones, triangular prisms, triangular based pyramids, cylinders, spheres, rhombohedra, pentagonal prism, tetrahedron and combinations thereof,
placing one or more digital three dimensional models into a digital three dimensional scene residing inside a programmed computer at varying depths and positions,
applying, using a programmed computer, algorithms, effects or applications to the digital three dimensional scene to reproduce the realistic application of lighting, shadow, absorption, reflection, refraction, florescence and transport,
rendering, using a programmed computer, the three dimensional scene into a two dimensional digital image,
creating a composite repeatable pattern of the rendered two dimensional digital image of a natural environment or plurality of digital three dimensional shapes, the pattern having a plurality of three dimensional models placed at varying depths and with varying focus,
wherein the three dimensional models have coloration which include natural colors of the modeled animal, object, the environment, primary or non-primary colors.

7. A method of making a camouflage pattern with an appearance of realism greater than an illustrated, photographic or photographic based pattern, comprising:
rendering, using a programmed computer, a digital two dimensional image of a digital three dimensional scene residing within a programmed computer with a plurality of digital three dimensional models of physical objects or geometric shapes placed at varying depths into the three dimensional scene,
repeating the two dimensional image of a digital three dimensional scene with a plurality of three dimensional models of physical objects or geometric shapes adjacent to each other providing the camouflage pattern for use on the article of manufacture.

8. The method of claim 6 further comprising:
the creation or selection of a digital three dimensional model of a natural object or solid geometric shape,
containing a digital three dimensional mathematical representation of a wire frame of the structure of a natural object or solid geometric shape,
containing a digital solid textured surface covering the three dimensional mathematical representation of a wire frame of the structure of a natural object or solid geometric shape,
containing primary or non-primary coloration.

9. The method of claim 6 further comprising the creation of a digital three dimensional mathematical representation of a wire frame of the structure of a natural object or solid geometric shape manually using software in a programmed computer.

10. The method of claim 6 further comprising the creation of a digital three dimensional mathematical representation of a wire frame of the structure of a natural object or solid geometric shape using an apparatus to scan a physical object utilizing contact, non-contact active, time-of-flight, triangulation, conoscopic holography, hand-held laser, structured light, modulated light, stereoscopic, photometric or silhouette scanning.

11. The method of claim 6 further comprising the creation of a three dimensional mathematical representation of a wire frame of the structure of a natural object or solid geometric shape using software in a programmed computer to convert a two dimensional photograph or image into a three dimensional wire frame model of the structure of a natural object or solid geometric shape.

12. The method of claim 6 further comprising the selection of a digital three dimensional mathematical representation of a wire frame of the structure of a natural object or solid geometric shape using a programmed computer to select a pre-created digital three dimensional wire frame model of the structure of a physical object or solid geometric shape from a database of pre-created models.

13. The method of claim 6 further comprising using a programmed computer to apply a solid textured surface to a digital three dimensional wire frame of the structure of a physical object or solid geometric shape.

14. The method of claim 6 further comprising using a programmed computer to apply natural, primary or non-primary coloration to the solid textured surface of a digital three dimensional wire frame model of the structure of a physical object or solid geometric shape.

15. The method of claim 6 further comprising printing the rendered two dimensional image as a repeating pattern on the substrate

16. The method of claim 15 wherein the substrate is clothing, a clothing accessory, a vehicle, or outdoor equipment.

17. A method of making a camouflage material, comprising:
forming an image of making a camouflage pattern with an appearance of realism greater than an illustrated, photographic or photographic based pattern on an image transfer medium, the pattern comprising repeating images of a two dimensional rendered three dimensional scene containing three dimensional models of environmental elements, physical objects or geometric shapes placed at various depths which includes trees, branches, leaves, rocks, grasses, plants, bushes, shrubs, ferns, reeds, water, wildlife, deer, turkeys, elk, moose, hogs, ducks, geese, fish, skulls, antlers, bones, cubes, cuboids, square based pyramids, cones, triangular prisms, triangular based pyramids, cylinders, spheres, rhombohedra, pentagonal prism, tetrahedron and combinations thereof, with the background being the image blurred through the use of focal depth and the three dimensional models placed at various depth have wherein the three dimensional models have effects or applications which replicate the realistic application of lighting, shadow, absorption, reflection, refraction, florescence and transport, and having coloration of which include natural colors of the physical object, environment, primary or non-primary colors.
